(19) United States
(12) Patent Application Publication
(10) Pub. No.: US 2010/0332349 A1
(43) Pub. Date: Dec. 30, 2010

(54) Systems and methods for fund transfers using prepaid calling cards and telephones

(75) Inventors: Francois Bonin, H/NO A4 Manet Gardens (GH); Herman Chinery-Hesse, Regimanuel Gray Estate (GH)

Correspondence Address: David A. Einhorn, Esq.;Baker & Hostetler LLP, 45 Rockefeller Plaza, New York, NY, 10111, US

(73) Assignee: Black Star Line

(21) Appl. No.: 12/456,917

(22) Filed: Jun. 24, 2009

(51) Int. Cl. G06Q 40/00; G06Q 30/00

(52) U.S. Cl. 705/27; 705/42

(57) ABSTRACT

Systems and methods are provided for electronically transferring funds between entities without requiring the entities to have an account with a financial institution. The system employs financial cards which customers can purchase. Each has a monetary value associated therewith. Subsequent to purchasing the card, the consumer can activate the card and then perform fund transfers by sending a request message to the system. The message identifies the card, the amount of the desired transfer and preferably, but not required, a PIN, the preferred destination of the funds, and the preferred recipient of the funds.

### FIELD OF THE INVENTION

The invention relates generally to financial transaction systems and methods and, more particularly, to systems and methods for transferring funds between entities using prepaid calling cards and phones.

### BACKGROUND OF THE INVENTION

In many locations, it is difficult for one party to transfer money to another party if one or more of the parties does not have a bank account or an account with some other financial institution. While there are companies that will provide these services for a fee, such as Western Union™ or the like, the costs for these services are expensive and these companies are not available in all locations. This problem is not unique to occupants of third world countries; however, it is especially pervasive in these countries. It is thus difficult to transfer funds to people living in third world countries.

In addition to the availability problems associated with transferring funds, there are also risks involved. Financial data transmitted electronically may be corrupted, deleted, added to, extracted, etc. Systems that involve the manipulation of financial information run the risk of being attacked in any or all of these ways.

Corruption includes: reattribution and modification. Reattribution is a situation where a given entity's financial data is reassigned to another entity thereby tying the new entity with the financial data and corresponding physical funds. In this manner entities can misappropriate funds of another entity or mask financial activities by attributing them to another entity. Modification of financial data is further subdivided in two possibilities: manipulation of the monetary values or modification of owner information. Either situation can result in negative consequences for the entities concerned and even the organization implementing the system containing the financial data.

Deletion of financial data may be employed to hide past transactions or financial activities or to erase records pertaining to a given entity in order to negatively affect an entity's financial position. Addition entails creating new financial data to be included in a system. This new data could be unrelated to anything legitimately belonging to the system and could credit an entity with funds that do not exist or tie an entity with financial transactions carried out by some other entity. Extraction refers to the unauthorized access and retrieval of data. This information may be employed by third parties to gain knowledge of financial information pertaining to given entities or for identity theft.

Various conventional financial systems exist that present graphical user interfaces for system access over the Internet. Examples of such systems are online banking systems, e-commerce applications, financial systems customer support components, etc. For such systems, the possibility of attackers using the Internet as a medium to reach the financial information is an important concern. Standard Internet security measures, though useful and important, are not adequate. Successful attacks on Internet-accessible computer systems and the continuing series of security updates produced by Operating Systems manufacturers attest to the inherent vulnerability of such computer systems to Internet attacks. Furthermore, the closed nature of most available Operating Systems precludes the verification by implementing organizations that no back-doors exist within the systems built on such Operating Systems.

It would thus be advantageous to create systems and methods for electronically transferring funds to and/or from entities who do not have an account with a financial institution. It would also be advantageous to provide such systems and methods with the financial data and the physical system being relatively secure against third-party attacks carried out remotely over the Internet or a local network.

### BRIEF SUMMARY OF THE INVENTION

Many advantages of the invention will be determined and are attained by the invention, which in a broadest sense provides systems and methods for transferring funds between entities. In at least some embodiments it provides systems and methods for electronically transferring funds between entities without requiring both entities to have an account with a financial institution. Implementations of the invention may provide one or more of the following features.

An aspect of the invention provides a system to facilitate a secure electronic transfer of funds between entities without requiring the entities to have an account with a financial institution. The system includes a card having both an identifier and a card value. The system also includes a server. The server, which could include multiple servers, is configured to store information related to the card. Information that the server is configured to store includes the identifier and the card value. The server is selectively accessible from a remote location and is configured to receive a request to transfer at least a portion of the card value to a location that is remote from the card. The server is also configured to transfer the requested value to a location which is remote from the card and to debit the card value by the amount transferred.

Another aspect of the invention provides a method for transferring funds between entities wherein at least one of the entities does not have an account with a financial institution. The method includes providing a card having a discrete monetary value to an entity. The method also includes associating, on a server in the system, the card with the entity and the card value with the card. The method further includes receiving at the server a request to transfer an amount of the card value to another entity. The request includes an identification of the card, an amount to be transferred, and the destination of the transfer. The method also includes transferring the requested amount to the destination and sending a confirmation for receipt by the requesting entity. The confirmation includes a reference identifier for retrieving the transferred amount.

In another aspect of the invention, a method is provided for transferring funds between entities wherein at least one of the entities does not have an account with a financial institution. The method includes an entity purchasing a card that has a hidden identifier and a discrete monetary value. The entity reveals the hidden identifier, selects a personal identification number (PIN) to associate with the card, and provides the PIN and the revealed identifier to the system to activate the card. The entity subsequently sends a request for the system to transfer at least a portion of the card value to another entity. The request includes an identification of the card, the amount to be transferred, and the destination of the transfer. In response to the request, the entity receives a confirmation, which includes a reference identifier for retrieving the transferred amount.

Still another aspect of the invention provides a system for facilitating a secure electronic transfer of funds between entities without requiring the entities to have an account with a financial institution. The system includes a card, which has identifying aspects which can be used for identifying and validating the card. The card also includes a card value. The system also includes a storage module for storing information related to the card. The stored information includes at least a portion of the identifying aspects and the card value. The storage module is also selectively accessible from a remote location. The storage module is configured to receive a request to transfer at least a portion of the card value to a location that is remote from the card. The storage module is also configured to transfer the at requested portion of the card value to the remote location and to debit the transferred amount from the card value.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is an diagram of a system for electronically transferring funds between entities without requiring both entities to have an account with a financial institution in accordance with an embodiment of the invention;

FIG. 2 is a flow chart illustrating a method for electronically transferring funds between entities without requiring both entities to have an account with a financial institution in accordance with an embodiment of the invention;

FIG. 3 illustrates is a block diagram of a monetary card that may be employed with embodiments of the invention; and,

FIG. 4 illustrates the monetary card of FIG. 3 after it has been activated for use with embodiments of the invention.

The invention will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

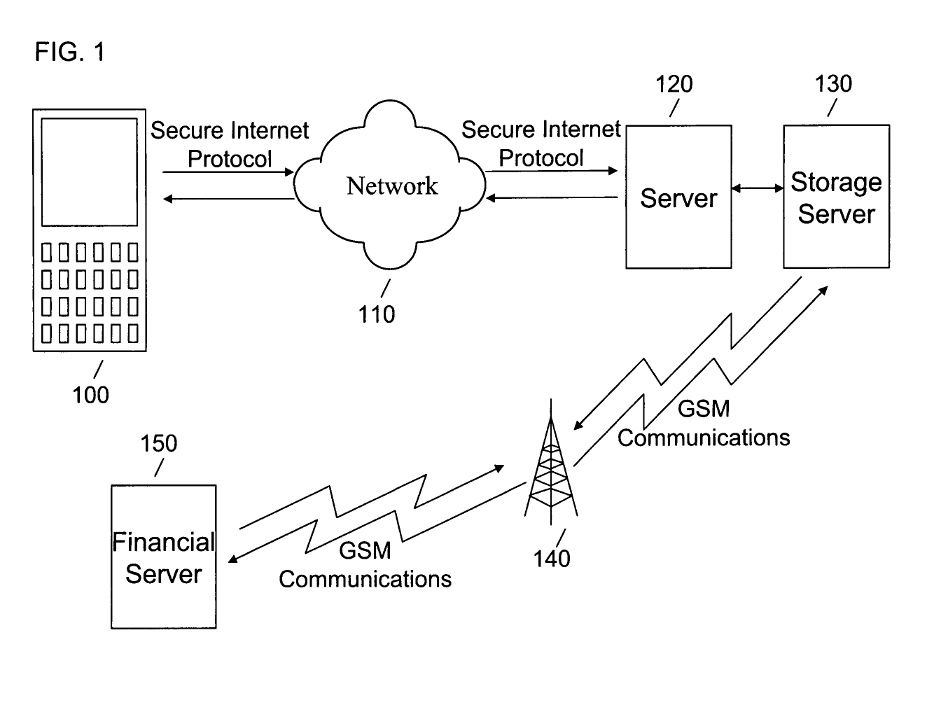

Referring to the drawings in detail wherein like reference numerals identify like elements throughout the various figures, there is illustrated in FIGS. 1-4 systems and methods for electronically transferring funds between entities without requiring both entities to have an account with a financial institution according to the invention. The principles and operations of the invention may be better understood with reference to the drawings and the accompanying description.

The term entity is intended to have the broadest meaning possible and may include people or businesses.

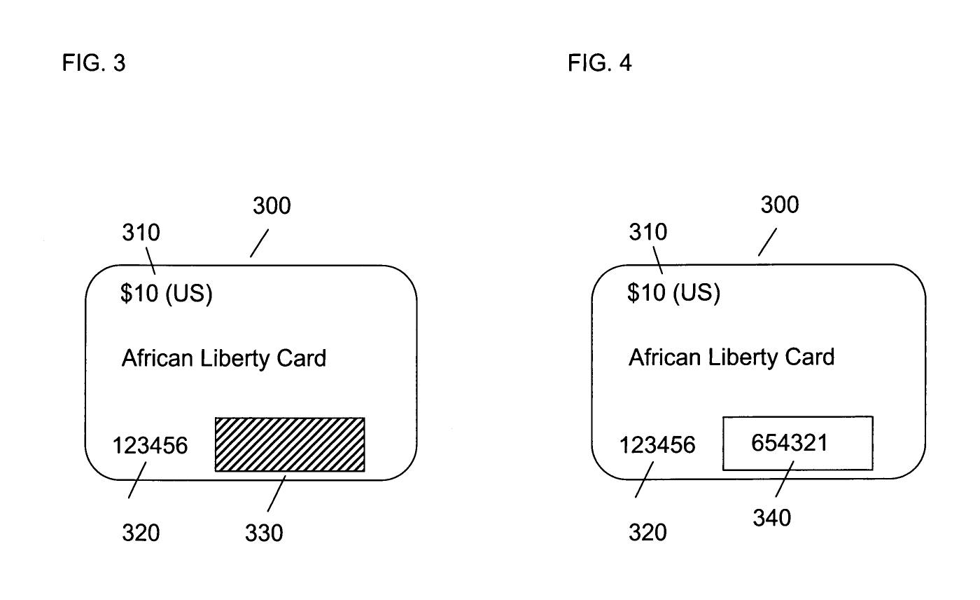

In a preferred embodiment of the invention, a card 300, illustrated in FIG. 3, which may be similar to a phone card is provided. The card 300 may include the value 310 of the card 300 printed or embossed on a face of the card 300. The value 310 may also include the currency. The card 300 may also include advertisements and/or the name of the company or companies that are providing the system/service (not shown) and/or instructions for how to activate the card and/or websites where the card may be employed to make purchases. Those skilled in the art will recognize that while the denominations and currency illustrated in FIGS. 3 and 4 are 10 US dollars, virtually any denomination or currency could be employed without departing from the scope of the invention. Additionally, while not preferred, it is considered within the scope of the invention that, a single card could be employed with multiple currencies. It is also considered within the scope of the invention that the card could be provided with no indication on its face as to its monetary value. Also not illustrated, the card could be provided with a magnetic strip to make the card machine readable. Also illustrated on the card 300 is an identification number 320. While preferably numerical this identification could be letters, numbers, symbols or a combination thereof. Also present on the card is a scratch of section 330. This scratch off section 330 allows a second identification 340 (FIG. 4) to be hidden until the card 300 is activated by the customer. This identification 340 (FIG. 4) may also be letters, numbers, symbols or a combination thereof. While the card 300 illustrated in FIGS. 3 and 4 depict identification numbers 320 and 340 as 6 digit numbers those skilled in the art will recognize that this is being done strictly for illustrative purposes and is merely a design choice. The number of digits employed for the identification numbers 320 and 340 could be 6, more than 6 or less than six and the two identification numbers 320 and 340 do not have to be the same number of digits.

FIG. 1 illustrates a general architecture of a system which enables an entity to transfer funds to one or more other entities in accordance with the invention. As illustrated, the system includes generally 2 information flow paths. The first path includes an entity at an access point 100 such as a computer terminal, a personal digital assistant (PDA), a cell phone, a point of service terminal with a card swipe, or any other network communication terminal, connected via a secure Internet connection or some other secure communication connection 110 to a server 120. Server 120, which is selectively in communication with network 110 is further connected to Information server 130. While the network 110 is depicted as the Internet, other communications networks may be employed without departing from the scope of the invention. Server 120 is connected to a storage server 130 via a secure network connection. Storage server 130 is configured to store and process operational information such as data relationship records, and policy data. Those skilled in the art will recognize that servers 120 and 130 could be the same server or multiple servers without departing from the scope of the invention. Further, the connection could be a hardwire connection a wireless connection or a standard network connection. The second path includes secure communications between the storage server 130 and a financial server 150. Financial server 150 is configured to store and process financial information. Those skilled in the art will recognize that while financial server 150 has been illustrated as a single separate server, it could be the same server as servers 120 and/or 130 and still fall within the scope of the invention. Further, while only 3 individual servers have been illustrated, a typical system could include multiple servers configured to perform these tasks. As illustrated in FIG. 1, storage server communicates with financial server via a global system for mobile communication (“GSM”) network 140. Each server could be a stand alone computer, an adjunct to one of the other servers, or one or more software program(s) running on the other server(s).

In operation, a currency card 300 is purchased by a consumer 100. The consumer 100 activates the card 300 and then can either transfer funds or make a purchase up to the amount of the card. Multiple cards may be employed for larger transfers or purchases. To purchase a card 300, a customer record is created. A preferred record includes customer name and address, mobile phone number, card identification number, card value and card currency. However, those skilled in the art will recognize that less than all of this information, different information and/or additional information could be required and still fall within the scope of the invention. Once the initial customer record has been established, the cardholder 100 can purchase one or more cards 300 and then activate the card(s) 300 for use. Activation includes scratching off section 330 to reveal a hidden card identifier 340. The cardholder 100 selects a personal identification number (“PIN”) and sends both the PIN and the hidden identifier 340 in a text message to the service provider. In a preferred embodiment the message will be sent to storage server 130 through server 120, although it could be sent to a verification server (not shown) or a person (not shown) and still fall within the scope of the invention. The service provider looks up the hidden identifier 340, which is associated in a file or database or in any other conventional manner of storing an association between two numbers, and determines whether the hidden identifier 340 is valid, is a duplicate of a previously entered number, and is associated with a valid card identifier 320. If the hidden number is valid, the PIN is associated with the card 300 and a message is returned to the cardholder 100 confirming that the card 300 has been activated.

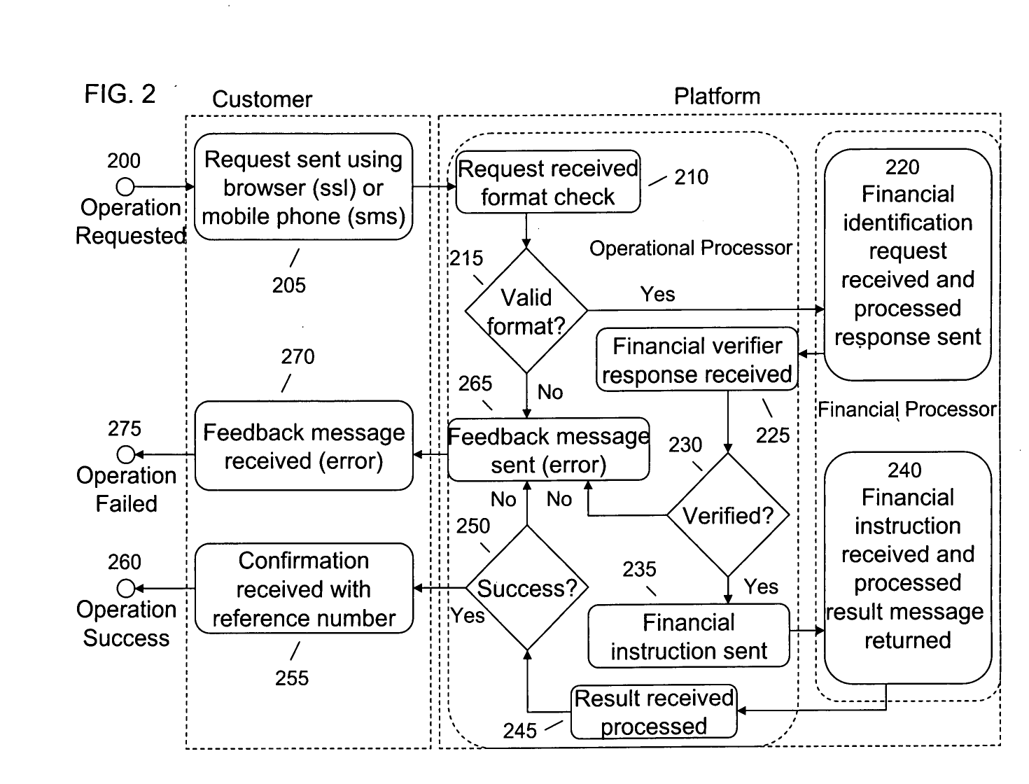

As illustrated in FIG. 2, once a card 300 is activated it may be employed to make online purchases or to transfer funds to another entity. The cardholder 100 enters details of the requested transaction at 200 into her mobile phone. The details include card number 320, the PIN, an amount to be transferred, where the funds should be received and the recipient's full name. Those skilled in the art will recognize that additional information could be requested. Further, it is considered within the scope of the invention that the cardholder 100 could enter a general location (e.g. a city or a zip code, or a town, etc) and receive a choice of available destinations in return. It is also possible that some other identifier could be employed for the recipient other than their full name and still fall within the scope of the invention. Once the cardholder 100 enters the information into her phone that message is sent to the server 120 (FIG. 1). Server 120 determines if the message is properly formatted at 215 and if so forwards the message to storage server 130 for processing 220. If the format of the message is improper, storage server 130 informs server 120 and an error message is returned to cardholder 100 (at 265, 270 and 275). If the message format is determined to be valid, storage server 130 communicates with financial server 150 to determine if there is an available balance on the card and the available balance is sufficient for the requested transfer (at 230, 235). If there are insufficient funds for the transfer, an error message is returned to cardholder 100 at 265, 270 and 275. If there are sufficient funds, financial server 150 processes the transaction at 240, 245 and a feedback message is sent to cardholder 100 at 255, 260. The feedback message includes a reference number which the cardholder 100 can provide to the intended recipient. The intended recipient can then retrieve the funds at the determined destination using the reference number.

Thus it is seen that systems and methods are provided for electronically transferring funds between entities without requiring both entities to have an account with a financial institution according to the invention. Although particular embodiments have been disclosed herein in detail, this has been done for purposes of illustration only, and is not intended to be limiting with respect to the scope of the claims, which follow. In particular, it is contemplated by the inventor that various substitutions, alterations, and modifications may be made without departing from the spirit and scope of the invention as defined by the claims. For example, the system is described being set up as multiple servers that communicate over different types of networks. However, the system could also function as a single server configured to perform all of the operations. Further, while security might not be as reliable, it is possible that all of the servers could communicate via the same network. Rather than entering the request messages into a mobile phone and sending the message, a website could be employed in which the cardholder enters information into a form on the web site. Additionally, rather than having the cardholder select the PIN, a PIN could be assigned to a cardholder. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A system to facilitate a secure electronic transfer of funds between entities without requiring the entities to have an account with a financial institution, the system comprising:
a card having both an identifier and a value; and,
a server configured to store information related to said card, wherein said information includes said identifier and said value; said server being selectively accessible from a remote location; wherein said server is configured to receive a request to transfer at least a portion of said value to a location remote from said card, to transfer the at least a portion of said value to said location remote from said card and to debit the at least a portion of said value from said value of said card.

2. The system according to claim 1 further comprising:
said card having another identifier that is hidden from view and configured to be revealed to activate said card for use with said system; and,
said server being further configured to store a relationship between said identifier and said another identifier and to refuse to activate said card unless the two identifiers match the stored relationship.

3. The system according to claim 1 wherein said server comprises multiple servers in selective communication.

4. The system according to claim 3 wherein at least one of said plurality of servers communicates with another of said plurality of servers via a secure link.

5. The system according to claim 1 wherein said value includes a plurality of values and wherein each of said plurality of values is in a different currency.

6. A method of transferring funds between entities wherein at least one of the entities does not have an account with a financial institution, said method comprising:
providing a card to an entity, said card having a discrete monetary value;
associating on a server in said system, said card with said entity and said value with said card;
receiving at said server a request to transfer at least a portion of said value to another entity; wherein said request includes an identification of said card, an amount to be transferred, and the destination of the transfer;
transferring said amount to said destination; and,
sending a confirmation for receipt by said entity, wherein said confirmation includes a reference identifier for retrieving said transferred amount.

7. The method according to claim 6 further comprising:
associating a personal identification number (PIN) with said card and including said PIN with said request to transfer.

8. The method according to claim 6 further comprising:
including a recipient's name with said request.

9. The method according to claim 6 further comprising:
providing an identifier on said card and a hidden identifier on said card; wherein said hidden identifier is revealed to activate said card for use with the system.

10. The method according to claim 6 further comprising said entity making a purchase from a merchant's website, wherein said merchant is identified in said request as the destination of the transfer.

11. A method of transferring funds between entities wherein at least one of the entities does not have an account with a financial institution, said method comprising:
an entity purchasing a card, said card having a hidden identifier and a discrete monetary value;
said entity revealing said hidden identifier;
said entity selecting a personal identification number (PIN) to associate with said card;
said entity providing said PIN and said revealed identifier to said system to activate said card;
said entity sending a request to said system to transfer at least a portion of said value to another entity; wherein said request includes an identification of said card, an amount to be transferred, and the destination of the transfer;
said entity receiving, in response to said request, a confirmation, wherein said confirmation includes a reference identifier for retrieving said transferred amount.

12. The method according to claim 11 further comprising:
said entity communicating said reference identifier and said destination to said another entity.

13. A system to facilitate a secure electronic transfer of funds between entities without requiring the entities to have an account with a financial institution, the system comprising:
a card having identification means for identifying and validating said card and a value; and,
a storage means for storing information related to said card, wherein said information includes at least a portion of said identification means and said value; said storage means being selectively accessible from a remote location; wherein said storage means is also for receiving a request to transfer at least a portion of said value to a location remote from said card, to transfer the at least a portion of said value to said location remote from said card and to debit the at least a portion of said value from said value of said card.

14. The system according to claim 13 wherein said identification means comprises a plurality of identifiers, wherein at least one of said identifiers is hidden from view and configured to be revealed to activate said card for use with said system.

15. The system according to claim 13 wherein said storage means comprises multiple servers in selective communication with each other.

16. The system according to claim 13 wherein at least one of said plurality of servers communicates with another of said plurality of servers via a secure link.
